(19) United States
(12) Patent Application Publication
(10) Pub. No.: US 2024/0248681 A1
(43) Pub. Date: Jul. 25, 2024

(54) Computer-Implemented Method for Determining a Gaussian Integer Congruent to a Given Gaussian Integer Modulo a Gaussian Integer Modulus, Method for Determining a Reduction of a Given Gaussian Integer Modulo a Gaussian Integer Modulus and Cryptographic Method and Error-Correction Method

(71) Applicant: Siemens Aktiengesellschaft, München (DE)

(72) Inventors: Fabrizio De Santis, München (DE); Malek Safieh, München, Bayern (DE)

(73) Assignee: Siemens Aktiengesellschaft, München (DE)

(21) Appl. No.: 18/558,009

(22) PCT Filed: Apr. 25, 2022
(86) PCT No.: PCT/EP2022/060901

§ 371 Date: Oct. 30, 2023

(30) Foreign Application Priority Data
Apr. 30, 2021 (DE) 10 2021 204 379.8
May 14, 2021 (DE) 10 2021 204 916.8
Jun. 7, 2021 (EP) 21178084.6

(51) Int. Cl. G06F 7/48

(52) U.S. Cl. CPC G06F 7/4806

(57) ABSTRACT

Various embodiments of the teachings herein include methods for determining a Gaussian integer congruent to a given Gaussian integer modulo. The method may include: starting with a Gaussian integer base raised to an integer exponent having a norm smaller than or equal to that of the Gaussian integer modulus and larger than the norm of the difference of the Gaussian integer base raised to the integer exponent and the Gaussian n integer modulus; initializing a variable value candidate for the Gaussian integer congruent with the given Gaussian integer; then iteratively decrementing the variable value by a product of the Gaussian integer modulus and a component-wise down rounded quotient of the current value of the variable value candidate and the Gaussian integer base raised to the integer exponent, as long as the quotient is not vanishing; and identifying the resulting variable value candidate as the Gaussian integer congruent.

### CROSS-REFERENCE TO RELATED APPLICATIONS

This application is a U.S. National Stage Application of International Application No. PCT/EP2022/060901 filed Apr. 25, 2022, which designates the United States of America, and claims priority to DE Application No. 10 2021 204 379.8 filed Apr. 30, 2021, DE Application No. 10 2021 204 916.8 filed May 14, 2021, and EP Application No. 21178084.6 filed Jun. 17, 2021, the contents of which are hereby incorporated by reference in their entirety.

### TECHNICAL FIELD

The present disclosure relates to cryptographic methods. Various embodiments of the teachings herein include computer-implemented methods for determining a Gaussian integer congruent to a given Gaussian integer modulo a Gaussian integer modulus, methods for a complete modulo reduction of a given Gaussian integer with a Gaussian integer modulus, computer-implemented cryptographic methods, and/or computer-implemented error-correction methods.

### BACKGROUND

Gaussian integers are a subset of the complex numbers having integers as real and imaginary parts. The set of Gaussian integers together with addition and multiplication modulo a Gaussian integer modulus forms either a ring or a field depending on the choice of the modulus. For this reason, Gaussian integers find applications in error-correcting coding theory, cryptography, and other fields of sciences.

For example, the set of Gaussian integers with addition and multiplication modulo a Gaussian integer modulus π forms a finite Gaussian integer field, if ππ*=p is prime and thus an ordinary integer. Note that the notion π* denotes the complex conjugate of n. In this case, the resulting Gaussian integer field is isomorphic to the prime field GF(p) over ordinary integers. Such an isomorphism exists for any prime p congruent to 1 modulo 4.

Like for the case of ordinary integers, the straightforward implementation of a modulo reduction of a given Gaussian integer is typically quite inefficient, because it requires a division of a Gaussian integer followed by a rounding of the result. Hence, more efficient reduction mechanisms for Gaussian integers are needed.

In the fields of cryptography and error-correction codes, congruent solutions with a smaller norm or absolute value than the original given Gaussian integer are heavily used and typically computed relatively inefficient.

### SUMMARY

The teachings of the present disclosure include methods and/or systems for an efficient reduction of a given Gaussian integer with a Gaussian integer modulus. Various methods for determining a Gaussian integer congruent to a given Gaussian integer modulo a Gaussian integer modulus with reduced complexity would be beneficial for many applications. Cryptographic methods and error-correction methods would significantly benefit from efficient reduction methods as mentioned above and are highly desired.

For example, some embodiments include a Computer-implemented method for determining a Gaussian integer congruent to a given Gaussian integer modulo a Gaussian integer modulus, wherein a Gaussian integer base raised to an integer exponent having a norm smaller than or equal to that of the Gaussian integer modulus and larger than the norm of the difference of the Gaussian integer base raised to the integer exponent and the Gaussian integer modulus is considered, and wherein a variable value candidate for the Gaussian integer congruent is considered that is first initialized with the given Gaussian integer and then iteratively decremented by a product of the Gaussian integer modulus and a component-wisely down rounded quotient of the current value of the variable value candidate for the Gaussian integer congruent and the Gaussian integer base raised to the integer exponent, as long as the quotient is not vanishing, whereafter the resulting variable value candidate for the Gaussian integer congruent is determined as the Gaussian integer congruent.

In some embodiments, the norm of the determined Gaussian integer congruent is smaller than the norm of the given Gaussian integer.

In some embodiments, the norm denotes the absolute value.

In some embodiments, the norm denotes the Manhattan weight or the absolute square value.

In some embodiments, the method is conducted on a computer that stores numbers in a positional numeral system with a radix, wherein the radix is equal to the integer base number.

In some embodiments, the Gaussian integer base is an ordinary integer base and may be 2.

In some embodiments, the variable value candidate is iteratively decremented involving subtracting a product of the Gaussian integer modulus and the component-wisely down rounded quotient of the current value of variable value candidate and the Gaussian integer base raised to the integer exponent.

In some embodiments, the variable value candidate is iteratively decremented involving adding a product of the component-wisely down rounded quotient of the variable value candidate and the Gaussian integer base raised to the integer exponent and the difference of the Gaussian integer base raised to the integer exponent and the Gaussian integer modulus.

In some embodiments, the variable value candidate is iteratively decremented involving bit shifting by an integer number of bits that is equal to the integer exponent that the Gaussian integer base is raised to and involving bit truncation down to an integer number of bits that is equal to the integer exponent.

In some embodiments, the difference of the Gaussian integer base raised to an integer power and the Gaussian integer modulus is composed of a sum of a first further integer base raised to first superscript and the first further integer baser raised to a second superscript multiplied with the imaginary unit.

In some embodiments, the Gaussian integer modulus is a Gaussian integer modulus, where the multiplication of this modulus with its conjugate is a prime ordinary integer.

In some embodiments, the Gaussian integer base is the sum of an ordinary integer raised to a third integer superscript, and the product of the imaginary unit with the ordinary integer raised to the third integer superscript.

As another example, some embodiments include a computer-implemented method for determining a reduction of a given Gaussian integer modulo a Gaussian integer modulus, wherein first a Gaussian integer congruent to a modulo reduction of a given Gaussian integer modulo a Gaussian integer modulus is determined with the method according to one of the preceding claims and the Gaussian integer congruent is further reduced with a final reduction.

As another example, some embodiments include a computer-implemented cryptographic method, particularly for generating a cryptographic key and/or for encryption or decryption, wherein a Gaussian integer congruent to a modulo reduction of a given Gaussian integer modulo a Gaussian integer modulus is determined using one or more of the methods as described herein and/or wherein a reduction of a given Gaussian integer modulo a Gaussian integer modulus is determined using one or more of the methods described herein.

As another example, some embodiments include a computer-implemented error-correction method, wherein a congruent to a modulo reduction of a Gaussian integer with a Gaussian integer modulus is determined using one or more of the methods described herein and/or wherein a reduction of a Gaussian integer modulo a Gaussian integer modulus is determined using one or more of the methods described herein.

### DETAILED DESCRIPTION

The teachings of the present disclosure allow implementation of an efficient reduction method for a class of Gaussian integer moduli of special form that boils down to a sequence of elementary bit operations, hence providing a very fast way to implement modulo reduction (both software and hardware) for a large class of Gaussian integer moduli.

A classic and direct approach for a modulo reduction of a given Gaussian integer x modulo a Gaussian integer modulus n uses a subtraction, a multiplication by a constant, and a division with rounding, like shown in the following formula:

$$x mod π = x - [ ( x {π}^{*} ) / ( {ππ}^{*} ) ] \cdot π .$$

Again, the notion π* denotes the complex conjugate of π, and the square brackets denote the operation of rounding.

A more efficient method for performing a modulo reduction of a given Gaussian integer modulo a Gaussian integer modulus is described in the following article: Safieh, Malek; Freudenberger, Jürgen: “Montgomery Reduction for Gaussian Integers”, Cryptography 2021, 5, 6 (https://doi.org/10.3390/cryptography5010006).

Likewise, fast reduction methods for a special class of ordinary integers are known. However, efficient reduction methods for Gaussian integers are less developed. Thus, the teachings herein address the important use case of given Gaussian integers, which are not ordinary integers.

In some embodiments, the modulo reduction may be performed in two parts: in a first part, a Gaussian integer congruent replacing the given Gaussian integer is determined, which is smaller than the given Gaussian integer, with respect to a norm such as the absolute value, but congruent to a final reduced result. In a second part, the congruent result may be reduced to obtain the final result of the modulo reduction, which is the correct representative from the Gaussian integer ring or field. Both aspects, the determination of the Gaussian integer congruent and the complete reduction, are subject of the current invention.

An efficient algorithm for the modulo reduction of given Gaussian integers in two parts as described above is disclosed. The first part is new and leads to different algorithmic steps and arithmetic operations than those described in prior art. This first part may be combined with a second part known from Safieh, Malek; Freudenberger, Jürgen: “Montgomery Reduction for Gaussian Integers”, Cryptography 2021, 5, 6 (https://doi.org/10.3390/cryptography5010006) as steps 3 to 11 of Algorithm 2 which constitute prior art.

Both the first and the second part may be combined to perform a full modulo reduction. However, in practice the first part is performed more frequently, particularly during cryptographic computations, while the second part, that may be also referred to as the “final reduction” throughout this application, is performed only once at the end to obtain the final desired result, the so-called representative of the Gaussian integer ring or field, which is the result from a modulo reduction. Moreover, the second part is based on computationally intensive comparisons. Thus, the first part aims at reducing the number of these comparisons to decrease the total complexity.

Thus, particularly the novel part of determining a Gaussian integer congruent to a given Gaussian integer modulo a Gaussian integer modulus provides major benefits in the efficiency of modulo reductions of Gaussian integers. Furthermore, it enables a final reduction with reduced complexity, i.e., the final reduction presented as steps 3 to 11 of algorithm 2 in the article: Safieh, Malek; Freudenberger, Jürgen: “Montgomery Reduction for Gaussian Integers”, Cryptography 2021, 5, 6 (https://doi.org/10.3390/cryptography5010006).

The computer-implemented methods described herein may be used for determining a Gaussian integer congruent to a given Gaussian integer modulo a Gaussian integer modulus.

A Gaussian integer base raised to an integer exponent is chosen, such that the Gaussian integer base raised to the integer exponent has a norm that is smaller or equal to the corresponding norm of the Gaussian integer modulus, and that is larger than the corresponding norm of the difference of the Gaussian integer base raised to the integer exponent and the Gaussian integer modulus. Later on, particularly in the description of preferred embodiments, the difference of the Gaussian integer base raised to the integer exponent and the Gaussian integer modulus may be denoted as E.

A variable value candidate for the Gaussian integer congruent is considered that is first initialized with the given Gaussian integer and then iteratively decremented by a product of the Gaussian integer modulus and a quotient, which is a component-wisely down rounded quotient of the current variable value candidate for the Gaussian integer congruent and the Gaussian integer base raised to the integer exponent, as long as the quotient is not vanishing. Hereafter, the resulting variable value candidate for the Gaussian integer congruent determines the Gaussian integer congruent with reduced norm or absolute value, which directly enables the use of the final reduction presented as steps 3 to 11 of algorithm 2 in the article: Safieh, Malek; Freudenberger, Jürgen: “Montgomery Reduction for Gaussian Intergers”, Cryptography 2021, 5, 6 (https://doi.org/10.3390/cryptography5010006).

In this context, the wording “Gaussian integer congruent” denotes a Gaussian integer which is congruent to a given Gaussian integer modulo a Gaussian integer modulus. The teachings may also be directed to the goal of determining such a Gaussian integer congruent, that has a norm that is smaller than the norm of the given Gaussian integer. Determining such a Gaussian integer congruent directly enables the use of the final reduction presented as steps 3 to 11 of algorithm 2 in the article: Safieh, Malek; Freudenberger, Jürgen: “Montgomery Reduction for Gaussian Integers”, Cryptography 2021, 5, 6 (https://doi.org/10.3390/cryptography5010006).

In some embodiments, the Gaussian integer congruent determined with the method according to the invention has a norm that is smaller than the norm of the given Gaussian integer.

Throughout this application, the terms mentioned below have the following meaning:

The term Gaussian integer modulus denotes a complex modulus, that has an integer real part and an integer imaginary part. In general, the teachings are applicable to many Gaussian integer moduli of special form. In some embodiments, the teachings may be applied to such a Gaussian integer modulus that is not an ordinary integer.

Later on, particularly in the description of the example embodiments, the Gaussian integer modulus may also be denoted as π.

Throughout this application, the term given Gaussian integer refers to Gaussian integers, thus including ordinary integers. The given Gaussian integer may be denoted as z′ and may initialize the variable value candidate in what follows, particularly in the description of the example embodiments.

Throughout this application, the term Gaussian integer base raised to an integer exponent refers to a base, that is a Gaussian integer and that is raised to an exponent, which is an integer. Please note, that in general the Gaussian integer representing the Gaussian integer base that is raised to the integer exponent may be different from the given Gaussian integer mentioned previously and is called Gaussian integer base in what follows. Later on, particularly in the description of the example embodiments, the Gaussian integer base is denoted as β and the integer exponent may be denoted by n. Accordingly, the Gaussian integer base raised to the integer exponent is denoted as βⁿ. In some embodiments, the Gaussian integer base may be a Gaussian integer that is not an ordinary integer. In some embodiments, the Gaussian integer base may be an ordinary integer.

Throughout this application, the term variable value candidate for the congruent denotes a candidate for the congruent, that can take temporary and changing Gaussian integer values during the determination according to the methods described herein. However, the variable value candidate is—after completing each iteration of decrementing the variable value candidate by the product of the Gaussian integer modulus and the component-wisely down rounded quotient of the current variable value candidate for the Gaussian integer congruent and the Gaussian integer base raised to the integer exponent—always congruent to the given Gaussian integer modulo the Gaussian integer modulus. Later, the variable value candidate for the congruent may be denoted by z′, particularly in the description of the example embodiments.

It is understood, that the phrase “variable value candidate that is decremented by” a quantity means that this quantity is subtracted from the variable value candidate.

The methods described herein allow a more efficient determination of a Gaussian integer congruent to a given Gaussian integer modulo a Gaussian integer modulus. Iteratively decrementing the variable value candidate by the product of the Gaussian integer modulus and the component-wisely down rounded quotient of the current variable value candidate for the Gaussian integer congruent and the Gaussian integer base raised to the integer exponent can be performed computationally efficient with truncations and digit shifts.

A Gaussian integer base raised to an integer exponent is chosen such, that the Gaussian integer base raised to the integer exponent has a norm that is smaller or equal to the corresponding norm of the Gaussian r modulus, and that is larger than the corresponding norm of the difference of the Gaussian integer base raised to the integer exponent and the Gaussian integer modulus. It is understood, that this step of the method may also optionally be rephrased such that a Gaussian integer base raised to an integer exponent having a norm smaller than or equal to that of the Gaussian integer modulus and larger than the norm of the difference of the Gaussian integer base raised to the integer exponent and the Gaussian integer modulus is considered. In other words, considering a Gaussian integer base raised to an integer exponent that satisfies the mentioned condition may be rephrased as choosing a Gaussian integer base raised to an integer exponent that satisfies the mentioned condition.

In some embodiments, the norm denotes the absolute value. Hence, the norm of the variable value candidate means the absolute value of the variable value candidate and the norm of the given Gaussian integer means the absolute value of the given Gaussian integer. In some embodiments, other norms may be used, particularly the Manhattan weight or the absolute square value of the variable value candidate.

In some embodiments, the method is conducted on a computer that stores numbers in a positional numeral system with a radix, the radix being equal to the Gaussian integer base that, in this aspect of the invention, constitutes an ordinary integer base. The radix of the positional numeral system directly matches the Gaussian integer base. Hence, many operations in this algorithm may be conducted with positional shifts of digits in the positional numeral system. In this particularly useful aspect of the invention, the computational benefits provided are directly used and appropriated when conducting the method.

In some embodiments, the Gaussian integer base is an ordinary integer, particularly 2. Thus, the methods are directly applicable in computers that store numbers as binary numbers. Since this positional numeral system is widely used in the computational domain, particularly this aspect addresses almost all computational architectures currently available.

In some embodiments, the variable value candidate is decremented with subtracting a product of the Gaussian integer base raised to the integer exponent and the component-wisely down rounded quotient of the current value of the variable value candidate and the Gaussian integer base raised to the integer exponent. This operation may be performed particularly efficient since the down rounded quotient of the current value of the variable value candidate may be evaluated with a shift of digits to the right direction. In this aspect, the integer exponent, the Gaussian integer base is raised to, is the number of digits that the variable value candidate is shifted by to evaluate the quotient. For the Gaussian integer base being 2 and a binary numeral system with integer powers of the Gaussian integer base being equal to 2, this operation may be performed with low computational costs by applying conventional bit shifts to the right by a number of digits, that match the integer exponent. Whenever throughout the application the wording integer exponent is used, this term refers to the integer exponent, the Gaussian base number is raised to.

In other words, subtracting the product of the Gaussian integer base raised to the integer exponent and the component-wisely down rounded quotient of the current value of the variable value candidate and the Gaussian integer base raised to the integer exponent from the variable value candidate is equivalent to a truncation of the current value of the variable value candidate down to the right-most digits, the number of the right-most digits being the integer exponent the Gaussian integer base is raised to.

The component-wise down rounding of the quotient may be easily achieved by applying digit shifts to the right direction, respectively.

In some embodiments, the variable value candidate is iterative decremented with adding a product of the component-wisely down rounded quotient of the variable value candidate and the Gaussian integer base raised to the integer exponent and the difference of the Gaussian integer base raised to the integer exponent and the Gaussian integer modulus. This difference of the Gaussian integer base raised to the integer exponent and the Gaussian integer modulus is also denoted as ϵ in what follows, particularly in the description of preferred embodiments of the invention.

In general, the evaluation of the product of the difference of the Gaussian integer base raised to the integer exponent and the Gaussian integer modulus and the component-wisely down rounded quotient of the current value of the variable value candidate for the Gaussian integer congruent and the Gaussian integer base raised to the integer exponent involves a complex multiplication which may not induce much computational costs in case the aforementioned difference of the Gaussian integer base raised to the integer exponent and the Gaussian integer modulus is comparatively small.

In some embodiments, the decrementing of the variable value candidate of the Gaussian integer congruent involves bit shifting by an integer number of bits that is equal to the integer exponent of the Gaussian integer base to the integer exponent and involves bit truncation down to an integer number of bits that is equal to the integer exponent. Later on, this operation is denoted as z′−qβⁿ. As described in the previous aspects of the invention, many operations in the application of the methods involve bit shifts and bit truncations, if performed on a conventional binary computer system.

In some embodiments, such a Gaussian integer modulus is considered, that the difference of the Gaussian integer base raised to the integer exponent and the Gaussian integer modulus is composed of a sum of a first further Gaussian integer base raised to a first integer superscript and the further Gaussian integer base raised to a second integer superscript multiplied with the imaginary unit. Additional steps of the calculation may be conducted using computationally efficient calculus such as digit shifts. The first superscript may be denoted as r and the second superscript may be denoted as j in what follows.

The term “integer superscript” throughout this application means an “integer exponent” that is not necessarily equal to integer exponents mentioned previously in the application. Hence, in order to avoid confusion with previously mentioned integer exponents, the term integer superscript is used as an alternative term for such additionally introduced integer exponents.

In some embodiments, the Gaussian integer modulus is a Gaussian integer modulus, where the multiplication of this modulus with its conjugate is a prime ordinary integer. This particular case is of specific importance for cryptography, such as for generating cryptographic keys and for encryption or decryption, since Gaussian integer fields are considered in this case.

In some embodiments, the Gaussian integer base is a sum of an additional ordinary integer raised to a third integer superscript and the product of the additional ordinary integer raised to the third integer superscript with the imaginary unit and the difference of the Gaussian integer base to the integer exponent and the Gaussian integer modulus is an ordinary integer or an additional Gaussian integer. Later on, particularly in the description of example embodiments, the third superscript may also be denoted as k. The evaluation of the component-wisely down rounded quotient may be evaluated computationally efficient with digit shifts to the left-hand side in conventional numeral notation.

For binary numeral systems and even in case the aforementioned difference of the Gaussian integer base raised to the integer exponent and the Gaussian integer modulus is not a power of two or a sum of a power of two and a product of a further power of two and the imaginary unit, calculating the product of the component wisely down rounded quotient of the current value of the variable value candidate for the Gaussian integer congruent and the Gaussian integer congruent may be performed with applying bit shifts.

The first, second, and third integer superscripts as mentioned previously denote further integer exponents which are not necessarily identical to the integer exponent introduced previously in the description.

In the particular case, wherein the difference of the Gaussian integer base raised to the integer exponent and the Gaussian integer modulus is the sum of an additional ordinary integer base raised to a first integer superscript and the additional ordinary integer base raised to the second integer superscript, and wherein the Gaussian integer base is the sum of the additional ordinary integer base raised to the third superscript and the product of the additional ordinary integer base raised to the third superscript and the imaginary unit, the calculation necessary for the method according to the invention is particularly efficient: The evaluation of the product of the down rounded quotient of the current value of the variable value candidate for the Gaussian integer congruent and the Gaussian integer base raised to the integer exponent and the Gaussian integer base raised to the integer exponent involves only a truncation. Additionally, the evaluation of the product of the down rounded quotient of the current value of the variable value candidate for the Gaussian integer congruent and the Gaussian integer base raised to the integer exponent and the difference of the Gaussian integer base raised to the integer exponent and the Gaussian integer modulus only requires bit shifts to the left.

In a computer-implemented method for a reduction of a given Gaussian integer with a Gaussian integer modulus, at first a Gaussian integer congruent to a modulo reduction of a given Gaussian integer with the Gaussian integer modulus is determined with the method as described above and subsequently, the Gaussian integer congruent is further reduced with a final reduction. A part of the Montgomery reduction, namely the final part given by the steps 3 to 11 of algorithm 2 in the article: Safieh, Malek; Freudenberger, Jürgen: “Montgomery Reduction for Gaussian Integers”, Cryptography 2021, 5, 6 (https://doi.org/10.3390/cryptography5010006), constitutes a known reduction which—in combination with the method for determining a Gaussian integer congruent to a modulo reduction of a given Gaussian integer modulo a complex modulus—results in a computationally efficient reduction of Gaussian integers.

Some embodiments include a computer-implemented cryptographic method for generating a cryptographic key and/or for encryption or decryption. A Gaussian integer congruent to a modulo reduction of a given Gaussian integer with a Gaussian integer modulus is evaluated using a method as described above and/or a reduction of a given Gaussian integer with a complex modulus is evaluated using a method as described above.

A congruent to a modulo reduction of a Gaussian integer with a Gaussian integer modulus is evaluated using a method as described above and/or a reduction of a Gaussian integer with a Gaussian integer modulus is evaluated using a method as described above.

In the following, example embodiments are described in more detail:

The reduction algorithm is described below as algorithm 1 and contains in steps 1 to 6 a method for determining a congruent to a modulo reduction of a given Gaussian integer with a Gaussian integer modulus incorporating teachings of the present disclosure. This method represents the first part of algorithm 1. The second part of algorithm 1 is constituted by a final reduction to determine the correct representative from the Gaussian integer ring or field as used in the Montgomery method. Part 1 and part 2 together form the method for a desired reduction of a given Gaussian integer with a Gaussian integer modulus.

The full reduction algorithm according to algorithm 1 targets Gaussian integer moduli of the form π=βⁿ−ϵ, where |ϵ|<|βⁿ|≤|π|:

Algorithm 1: Efficient reduction for a class of given Gaussian
integers with Π = βⁿ − ϵ, where ϵ = βⁿ mod Π and | ϵ | < | βⁿ | ≤ | Π | .
The function “div βⁿ” describes a simple integer division by βⁿ.
The simplified shift and truncation operations for β = 2 are
applied for the real and imaginary parts separately. Note that z′
− qβⁿ + qϵ = z′ − qΠ.
Input: βⁿ, given Gaussian integer z′, and Π = βⁿ − ϵ.
Output: Gaussian integer z = z′ mod Π.

| 1: | q = z′ div βⁿ | //shift right by n for β = 2 |
|---|---|---|
| 2: | while (q ≠ 0 + 0i) do | |
| 3: | z″ = z′ − qβⁿ | // truncation to n-bits for β = 2 |
| 4: | z′ = z″ + qϵ, | // replace qβⁿ by qϵ since \| ϵ \| < \| βⁿ \| |
| 5: | q = z′ div βⁿ | // shift right by n for β = 2 |

| | |
|---|---|
| 6: | end while |
| 7: | apply a final reduction using z′ for providing z |

In the first part in step 1 to 6, a Gaussian integer z′ is determined, which is congruent to the correct result of the complete or desired ordinary modulo reduction. Since the Gaussian integer base in algorithm 1 is equal to 2, the evaluation of step 5 only requires bit shifts into the right direction for the real and the imaginary part. The second part in step 7, also called the final reduction throughout this application, uniquely determines the correct final result, which is the correct representative from the Gaussian integer field or ring, using the final reduction for Gaussian integers as described in steps 3 to 11 of algorithm 2 in Safieh, Malek; Freudenberger, Jürgen: “Montgomery Reduction for Gaussian Integers”, Cryptography 2021, 5, 6 as referenced in the previous description, the content of which is hereby included by reference.

Several cases, the algorithm 1 may be applied to, are distinguished in the following:

In general, for ordinary Gaussian integer bases β, here e. g. the ordinary integer β=2, step 3 in algorithm 1 involves simply a truncation. Furthermore, the evaluation of the product of the difference e of the Gaussian integer base raised to the integer exponent βⁿ and the Gaussian integer modulus n and the component-wisely down rounded quotient q of the current value of the variable value candidate z′ for the Gaussian integer congruent z′ and the Gaussian integer base raised to the integer exponent Bo, namely the product qϵ required in step 4 of algorithm 1, involves a complex multiplication which may not induce much computational costs in case the aforementioned difference e is comparatively small.

However, in case the aforementioned difference e is equal to a sum of a further integer base such as 2 raised to a first superscript r and the product of this further integer base 2 raised to a second superscript j and the imaginary unit, thus, ϵ=2^{r}+2^{j}i, and the Gaussian integer base β is an integer power of the further integer base 2, step 3 may be evaluated using truncation and qϵ is calculated with digit shifts, here bit shifts, to the left as described in the algorithm 2 below.

This case is explained in more detail with the first example concerning algorithm 2 below.

Likewise, in case the aforementioned difference e is not such a sum of a further integer base raised to a first integer superscript and the further integer base raised to the second integer superscript, and the Gaussian integer base is the sum of the further integer base raised to a third superscript and a product of the further integer base raised to the third superscript and the imaginary unit, step 3 may be performed with applying digit shifts such as bit shifts while step 4 still requires a complex multiplication.

In the particular case, wherein the difference e of the Gaussian integer base raised to the integer exponent and the Gaussian integer modulus is the sum of the further integer base raised to a first integer superscript and the further integer base raised to the second integer superscript, and wherein the Gaussian integer base is the sum of the further integer base raised to a third integer superscript and the product of the further integer base raised to the third integer superscript and the imaginary unit, step 3 of algorithm 1 requires digit shifts to obtain the product qβⁿ of the down rounded quotient q of the current value of the variable value candidate for the Gaussian integer congruent and the Gaussian integer base raised to the integer exponent and the Gaussian integer base raised to the integer exponent. In this case, the evaluation of the product qϵ of the down rounded quotient q of the current value of the variable value candidate for the Gaussian integer congruent and the Gaussian integer base raised to the integer exponent and the difference e only requires digit shifts to the left.

This last case is explained with the second example detailed in the embodiment of the second example of algorithm 2 as described below.

The final reduction step of algorithm 1 is costly for the implementation. However, for several applications like cryptography many interim results have to be calculated, for which a congruent solution is sufficient. Hence, for any congruent z′ with

$$max ( \vert Re \{ {z}^{′} \} \vert , \vert Im \{ {z}^{′} \} \vert ) \leq max ( \vert Re \{ π \} \vert , \vert Im \{ π \} \vert ) ,$$

the final reduction in step 7 of this algorithm 1 can be ignored, where Re{x} and Im{x} denote the real and imaginary parts of the Gaussian integer x, respectively. We note that there exist many such Gaussian integers, which are interesting for efficient error-correcting coding, cryptographic or other applications.

The complexity of the new derived first part in step 1 to 6 of this algorithm can be reduced for special forms of Gaussian integer moduli:

In a first example explained with algorithm 2, let the Gaussian integer base β=b be an ordinary integer and ϵ=b^{r}+b^{j}i be a Gaussian integer, where b is a convenient further Gaussian integer base. For b=2, the integer division z′ div βⁿ can be achieved with shifts of the real and imaginary parts of z′ by n bits to the right direction, respectively. Similarly, z″=z′−qβⁿ can be implemented by truncating the real and imaginary parts of z′ by n bits, respectively. Due to the used form of ϵ the complex multiplication in step 4, e.g. the multiplication qϵ, can be obtained with bit shifts by r and j to the left direction. Consequently, step 1 to 6 of this algorithm can be calculated using truncations, addition, subtraction, and shift operations, which is very efficient for the implementation. This concept is applicable for some Gaussian integer rings and fields, which is not possible for rings and fields over ordinary integers. The resulting reduction is summarized in the algorithm 2 for the Gaussian integer z being an element of the ring or field [symbol] p of size or order p, the order p being the absolute square of the Gaussian integer modulus:

Algorithm 2: Efficient reduction for given Gaussian integers to
obtain z′ = z mod Π with |Re{z′} | < 2ⁿ and | Im{z′} | < 2ⁿ, where the
given Gaussian integer z ϵ [symbol] ₚ, the Gaussian integer modulus Π = 2ⁿ
− (2^{r} + 2^{j}i), r and j are positive integers (or one of them is
zero) . The function mul (x, 2ⁿ) denotes a shift of x by n bits to
the left direction.
Input: given Gaussian integer z, n, r, and
Output: z′ = z mod Π with |Re{z′} | < 2ⁿ, | Im{z′} | < 2ⁿ

| 1: | Re{q} = Re{z′} div 2ⁿ | / / shift right Re{z′} by n |
|---|---|---|
| 2: | Im{q} = Im{z′} div 2ⁿ | / / shift right Im{z′} by n |
| 3: | while (Re{q}≠0 && Im{q}≠0) do | |
| 4: | x = Re{z′} & (2ⁿ − 1) | / / truncate Re{z′} to n-bits |
| 5: | y = Re{z′} & (2ⁿ − 1) | / / truncate Im{z′} to n-bits |
| 6: | Re{z′} = x + mul (Re{z′}, 2^{r}) − mul (Im{z′}, 2^{j}) | |
| 7: | Im{z′} = y + mul (Re{z′}, 2^{j}) + mul (Im{z′} , 2^{r}) | |
| 8: | Re{q} = Re{z′} div 2ⁿ | / / shift right Re{z′} by n |
| 9: | Im{q} = Im{z′} div 2ⁿ | / / shift right Im{z′} by n |
| 10: | end while | |
| 11: | return z′ | |

After these steps, also a final reduction can be performed.

In a second example, let β=(b^{k}+b^{k}i) be a Gaussian integer and E be an ordinary integer or a Gaussian integer, where b is a convenient basis.

For b=2, step 3 can be implemented using a subtraction and the second term qβⁿ can be achieved with bit shifts to the left direction. Furthermore, the integer division in step 1 and 5 of algorithm 1 can be defined as follows:

$${z}^{′} div {β}^{n} = ⌊ \frac{{z}^{′} {β}^{n}}{{{β}^{n} ( {β}^{n} )}^{*}} ⌋ ,$$

where (βⁿ)* is the complex conjugate of βⁿ. Due to the used form of β this operation can be implemented with simple bit shifts. Similarly, the complex multiplication qβⁿ in step 3 of algorithm 1 can be implemented with simple bit shifts to the left direction. Hence, the complexity of step 1 to 6 of algorithm 1 is dominated by the complex multiplication qϵ. Like in the previous concept, these multiplications provide low complexity for differences of the e values with low norm. Furthermore, these multiplication can be implemented with bit shifts to the left direction for ϵ=b^{r} or for ϵ=b^{r}+b^{j}i.

Since the computational costs for the first part of the reduction mainly arise from the multiplication qϵ, choosing an e with a norm that is much smaller than the Gaussian integer base raised to the integer exponent leads to significantly less computational costs even if ϵ does not have the form ϵ=b^{r} or ϵ=b^{r}+b^{j}i. Particularly when choosing this special class of ϵ, such multiplications may be performed even more efficiently by digit shifts to the left.

What is claimed is:

1. A method for determining a Gaussian integer congruent to a given Gaussian integer modulo a Gaussian integer modulus, the method comprising:
starting with a Gaussian integer base raised to an integer exponent having a norm smaller than or equal to that of the Gaussian integer modulus and larger than the norm of the difference of the Gaussian integer base raised to the integer exponent and the Gaussian integer modulus;
initializing a variable value candidate for the Gaussian integer congruent with the given Gaussian integer;
then iteratively decrementing the variable value by a product of the Gaussian integer modulus and a component-wise down rounded quotient of the current value of the variable value candidate for the Gaussian integer congruent and the Gaussian integer base raised to the integer exponent, as long as the quotient is not vanishing; and
identifying the resulting variable value candidate for the Gaussian integer congruent as the Gaussian integer congruent.

2. A method according to claim 1, wherein the norm of the determined Gaussian integer congruent is smaller than the norm of the given Gaussian integer.

3. A method according to claim 1, wherein the norm denotes the absolute value.

4. A method according to claim, wherein the norm denotes the Manhattan weight or the absolute square value.

5. A method according to claim 1, conducted on a computer that stores numbers in a positional numeral system with a radix, wherein the radix is equal to the integer base number.

6. A method according to claim 1, wherein the Gaussian integer base is an ordinary integer base.

7. A method according to e claim 1, further comprising iteratively decrementing the variable value candidate by subtracting a product of the Gaussian integer modulus and the component-wisely down rounded quotient of the current value of variable value candidate and the Gaussian integer base raised to the integer exponent.

8. A method according to claim 1, further comprising iteratively decrementing the variable value candidate by adding a product of the component-wisely down rounded quotient of the variable value candidate and the Gaussian integer base raised to the integer exponent and the difference of the Gaussian integer base raised to the integer exponent and the Gaussian integer modulus.

9. A Method according to claim 1, further comprising iteratively decrementing the variable value candidate by bit shifting by an integer number of bits that is equal to the integer exponent that the Gaussian integer base is raised to and involving bit truncation down to an integer number of bits that is equal to the integer exponent.

10. A method according to claim 1, wherein the difference of the Gaussian integer base raised to an integer power and the Gaussian integer modulus is composed of a sum of a first further integer base raised to first superscript and the first further integer baser raised to a second superscript multiplied with the imaginary unit.

11. A method according to claim 1, wherein the Gaussian integer modulus is a Gaussian integer modulus, where the multiplication of this modulus with its conjugate is a prime ordinary integer.

12. A method according to claim 1, wherein the Gaussian integer base is the sum of an ordinary integer raised to a third integer superscript, and the product of the imaginary unit with the ordinary integer raised to the third integer superscript.

13. A method for determining a reduction of a given Gaussian integer modulo a Gaussian integer modulus, the method comprising:
starting with a Gaussian integer base raised to an integer exponent having a norm smaller than or equal to that of the Gaussian integer modulus and larger than the norm of the difference of the Gaussian integer base raised to the integer exponent and the Gaussian integer modulus;
initializing a variable value candidate for the Gaussian integer congruent with the given Gaussian integer;
then iteratively decrementing the variable value by a product of the Gaussian integer modulus and a component-wise down rounded quotient the current value of the variable valve candidate for the Gaussian integer congruent and the Gaussian integer base raised to the integer exponent, as long as the quotient is not vanishing;
identifying the resulting variable value candidate for the Gaussian integer congruent as the Gaussian integer congruent; and
further reducing the Gaussian integer congruent with a final reduction.

14-15. (canceled)
